(19) United States
(12) Patent Application Publication
(10) Pub. No.: US 2011/0198157 A1
(43) Pub. Date: Aug. 18, 2011

(54) PALLET AND PRODUCT PROTECTOR

(76) Inventor: Geoff R. SHARP, Visalia, CA (US)

(21) Appl. No.: 12/983,450

(22) Filed: Jan. 3, 2011

Related U.S. Application Data
(60) Provisional application No. 61/338,152, filed on Feb. 16, 2010.

(51) Int. Cl. B66F 9/075

(52) U.S. Cl. 187/222

(57) ABSTRACT

A pallet and product protector for use with a forklift having a pair of L-shaped forks, including a front plate including a first bracket having a height, a middle plate having a height, a second bracket having a height, a first horizontally elongated portion having a height and extending between the first bracket and the middle plate, and a second horizontally elongated portion having a height extending between the second bracket and the middle plate, the height of the first horizontally elongated portion and the height of the second horizontally elongated portion being less than the height of the first bracket, the height of the middle plate, and the height of the second bracket; a vertically elongated plate disposed rearward of the front plate and coupled thereto, the vertically elongated plate further including a top end, a bottom end, and a pair of L-shaped members disposed adjacent the top end and extending rearward therefrom; and a clamping member disposed proximate to the middle plate of the front plate and below the vertically elongated plate.

### CROSS-REFERENCE TO RELATED APPLICATIONS

This application claims priority to U.S. Provisional Application 61/338,152, filed Feb. 16, 2010 and entitled PALLET AND PRODUCT PROTECTOR, the entire contents of which are hereby incorporated by reference.

### BACKGROUND

Lift trucks, also known as forklifts, are commonly used in warehousing, storage, and similar applications to transport packaged materials between locations, and to raise and stack packaged materials for storage. To facilitate transporting and lifting the materials, such materials are typically packaged and disposed on top of a pallet. Commonly used pallets are constructed from wood and have a bottom deck and a top deck coupled to a plurality of parallel stringers disposed therebetween, with openings provided between the stringers. A pallet can have a pair of stringers disposed at the edges of the pallet, and a third stringer disposed substantially halfway between the pair of stringers. Forklifts have a pair of movable L-shaped members, or forks, that are inserted into the openings. Once the forks are disposed within the openings, the forklift can lift and transport the pallet.

During operations, forklifts can impact the pallet with the vertical portions of the forks. The force of these impacts is applied to the top deck of the pallet and to the goods disposed on top of the pallet and that may be overhanging the pallet. Consequently, individuals and businesses suffer significant losses due to product damage, pallet damage, as well as due to the labor involved in replacing pallets and products and restacking products on undamaged pallets.

### SUMMARY

According to at least one exemplary embodiment, a pallet and product protector is disclosed. The pallet and product protector can include a front plate having a first bracket, a middle plate, a second bracket, a first horizontally elongated portion having and extending between the first bracket and the middle plate, and a second horizontally elongated portion extending between the second bracket and the middle plate, the height of the first horizontally elongated portion and the height of the second horizontally elongated portion being less than the height of the first bracket, the height of the middle plate, and the height of the second bracket; a vertically elongated plate disposed rearward of the front plate and coupled thereto, the vertically elongated plate further including a top end, a bottom end, and a pair of L-shaped members disposed adjacent the top end and extending rearward therefrom; and a clamping member disposed proximate to the middle plate of the front plate and below the vertically elongated plate.

According to another exemplary embodiment, a pallet and product protector can include a housing having a cavity sized to slidably receive a pair of arms therein; a first arm slidably disposed within the housing and adapted to be demountably coupled thereto, the first arm comprising at least one horizontally elongated portion and a bracket disposed at the outside end of the horizontally elongated portion; a second arm slidably disposed within the housing and adapted to be demountably coupled thereto, the right arm comprising at least one horizontally elongated portion and a bracket disposed at the outside end of the horizontally elongated portion; and a vertically elongated plate disposed rearward of the front plate, comprising a top end and a bottom end, and at least one L-shaped member disposed adjacent the top end and extending rearward therefrom.

### BRIEF DESCRIPTION OF THE FIGURES

FIG. 1a shows an exemplary embodiment of a pallet and product protector attached to a forklift.

FIG. 1b is a front isometric view of an exemplary embodiment of a pallet and product protector.

FIG. 1c is a rear isometric view of an exemplary embodiment of a pallet and product protector.

FIG. 1d is a front isometric view of another exemplary embodiment of a pallet and product protector.

FIG. 2a is an exploded rear isometric view of another exemplary embodiment of a pallet and product protector.

FIG. 2b is a front isometric view of another exemplary embodiment of a pallet and product protector in a first configuration.

FIG. 2c is a front isometric view of another exemplary embodiment of a pallet and product protector in a second configuration.

FIG. 2d shows another exemplary embodiment of a pallet and product protector attached to a forklift.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention”, “embodiments” or “invention” do not require that all embodiments of the invention include the discussed feature, advantage or mode of operation.

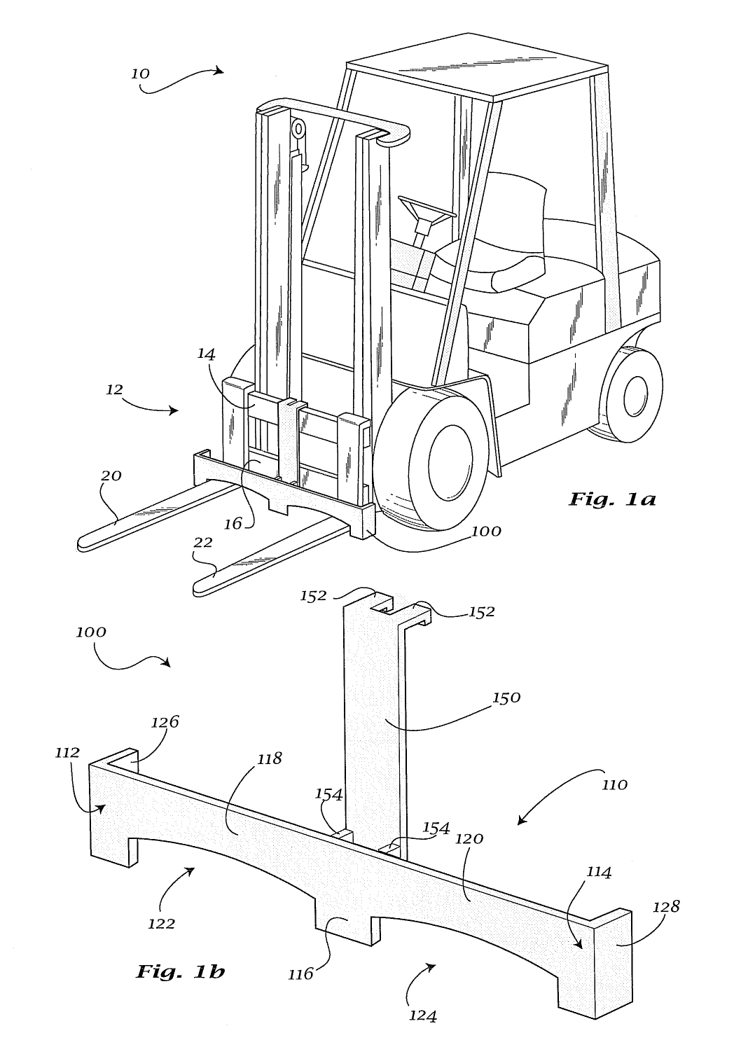

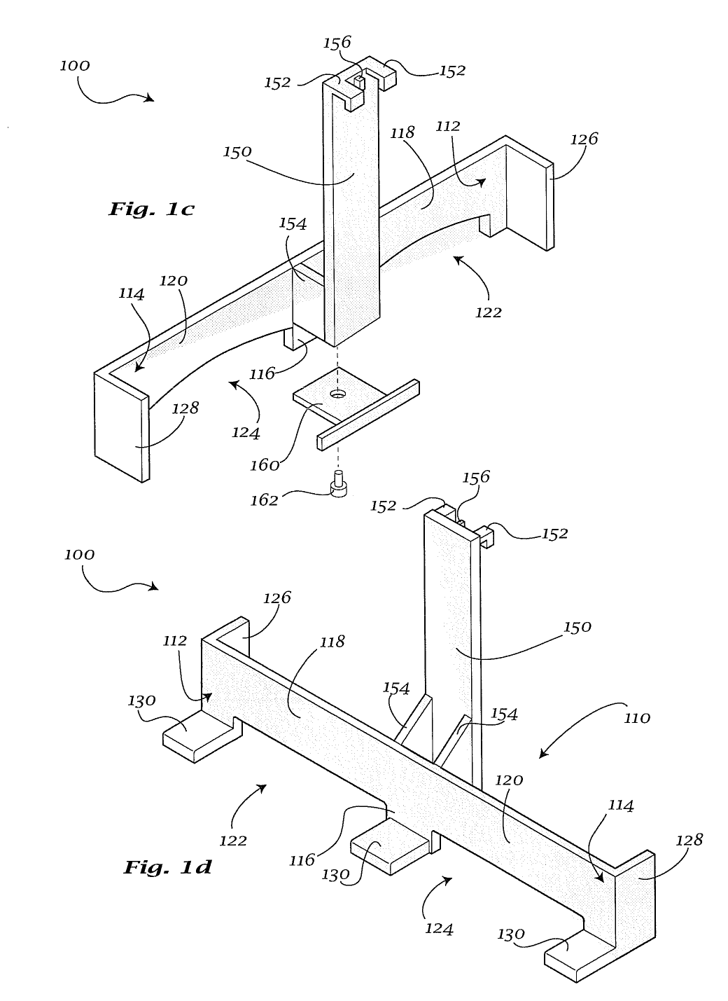

FIG. 1a shows am exemplary embodiment of a pallet and product protector 100 attached to a forklift 10 having a pair of L-shaped forks 20, 22. Typically, forks 20, 22 can be a part of a carriage assembly 12. The carriage assembly 12 can include an upper carriage bar 14 and a lower carriage bar 16. Carriage assembly 12 can be vertically adjustable, while forks 20, 22 can be laterally adjustable with respect to each other and to carriage assembly 12.

FIGS. 1b-1d show an exemplary embodiment of a pallet and product protector 100. Pallet and product protector 100 may include a horizontally elongated front plate 110 and a vertically elongated plate 150 disposed rearward of front plate 110 and coupled thereto. Plates 110 and 150 may be coupled such that front plate 110 is positioned substantially near the lower end of vertically elongated plate 150 and may extend below vertically elongated plate 150. Vertically elongated plate 150 may include a pair of L-shaped members 152 disposed adjacent the top end thereof. L-shaped members 150 may extend rearward and downward from vertically elongated plate 150 so as to provide a substantially hook-like configuration that may be removably attached to the upper carriage bar 14 of a forklift or similar apparatus by positioning the L-shaped members 152 over upper carriage bar 14.

Front plate 110 may include a first bracket 112, a second bracket 114, and a middle plate 116. Extending between first bracket 112 and middle plate 116 may be a first horizontally elongated portion 118, and extending between middle plate 116 and second bracket 114 may be a second horizontally elongated portion 120. The height of first and second horizontally elongated portions 118, 120 may be less than the heights of first bracket 112, second bracket 114, and middle plate 116. The bottom edge of front plate 110 may thus be shaped so as to symmetrically define first and second cutouts 122, 124, while the top edge of front plate may be substantially horizontal. In some embodiments, cutouts 122, 124 may have a substantially arcuate shape, or a shape having vertical sides and an arcuate top, as shown in FIGS. 1b-1c. In other embodiments, cutouts 122, 124 may have a three-sided rectangular shape, as shown in FIG. 1d. Additionally, first bracket 112 may include a rearward-extending portion 126, and second bracket 114 may likewise include a rearward-extending portion 128.

Cutouts 122, 124 may be sized to receive the horizontal tongs of L-shaped forks 20, 200 of a forklift 10. As a forklift 10 may have forks that are laterally adjustable, cutouts 122, 124 may be sized so as to allow for the full range of lateral adjustability of the L-shaped forks. Furthermore, as shown in FIG. 1a, vertically elongated plate 150 may be sized such that when vertically elongated plate 150 is attached to an upper carriage bar 14 of a forklift, L-shaped forks 20, 22 may be received within cutouts 122, 124, while first bracket 112, middle plate 116, and second bracket 114 may extend below the plane of L-shaped forks 22, 24.

A forklift 10 typically has carriage bars 14, 16 disposed behind L-shaped forks 20, 22. Thus, vertically elongated plate 150 may be coupled to front plate 110 by at least one spacer member 154. At least one spacer member 154 can have any desired width, so as to provide a desired clearance between plates 110, 150 such that vertically elongated plate 150 can be attached to upper carriage bar 14, while front plate 110 can be disposed in front of the vertical portions of L-shaped forks 20, 22.

Pallet and product protector 100 may further include a clamping member 160 that can be removably coupled to the bottom end of vertically elongated portion 150, or, alternatively, to a spacer member 154, or to a plate coupled thereto. Clamping member 160 may engage bottom carriage bar 16 of a forklift 10, so as to facilitate securing pallet and product protector 100 to carriage assembly 12. Furthermore, diverse models of forklifts may have varying distances between upper and lower carriage bars 14, 16. Therefore, the vertical position of clamping member 160 may be adjustable so as to allow pallet and product protector 100 to couple to diverse forklift models. The coupling of clamping member 160 may be facilitated by a fastener 162, for example a screw, bolt, or any other known fastener that allows the vertical position of clamping member 160 to be adjusted as desired.

Certain carriage bars may include a plurality of regularly spaced index notches provided along the upper portion of the carriage bar. Such index notches can facilitate the positioning of L-shaped forks or other attachments along the carriage bar. Exemplary embodiments of pallet and product protector 100 may thus include a centering nub 156 disposed substantially near the top end of vertically elongated plate 150. Centering nub 156 may be adapted to be received within an index notch of a carriage bar, so as to facilitate precise positioning of pallet and product protector 100 at the midpoint of the carriage bar or at another desired index notch.

Pallets may have materials loaded thereon that overhang the edge of the pallet. Embodiments of pallet and product protector 100 may include horizontal extensions 130 coupled to each of first bracket 112, second bracket 114, and middle plate 116, substantially near the bottom ends thereof. Extensions 130 may serve to provide additional clearance between the pallet and front plate 100 so as to reduce the likelihood of contact between materials that are overhanging the pallet and the forklift.

In operation, pallet and product protector 100 can be attached to the carriage assembly 12 of a forklift 10, substantially as described above and as shown in FIG. 1a. The operator can then proceed with loading the pallet onto the forklift, by inserting the horizontal portions of L-shaped tongs 20, 22 into the spaces provided between the stringers of a pallet. As the L-shaped tongs are moved into position underneath the pallet, front plate 110 can come into contact with, or can impact, the upper deck of the pallet. Furthermore, center plate 116 can come into contact with, or can impact, the middle stringer of the pallet, while first and second brackets 112, 114 can come into contact with, or can impact, the stringers disposed along the edges of the pallet. The impact force can thus be distributed along a greater contact area than if the pallet were to be impacted solely by the vertical portions of L-shaped forks 20, 22, and damage to the pallet may be prevented. Additionally, as pallet and product protector 100 is disposed forward of L-shaped forks 20, 22, and substantially at the height of the pallet when it is proximate to the forklift, any materials that are loaded on the pallet are not likely to come into contact with, or impact, forks 20, 22 or pallet and product protector 100, thereby reducing the likelihood of damage to the materials. Furthermore, extensions 130 may provide additional clearance between the pallet and the forklift, further reducing the likelihood of damage to the materials.

During pallet loading and unloading operations, a forklift may approach the pallet at an oblique angle. Oblique impacts may also impart damage to the pallet and to the materials loaded thereon. Therefore, the rearward extending portions 126, 128 of brackets 112, 114 may reduce the likelihood of damage from oblique impacts.

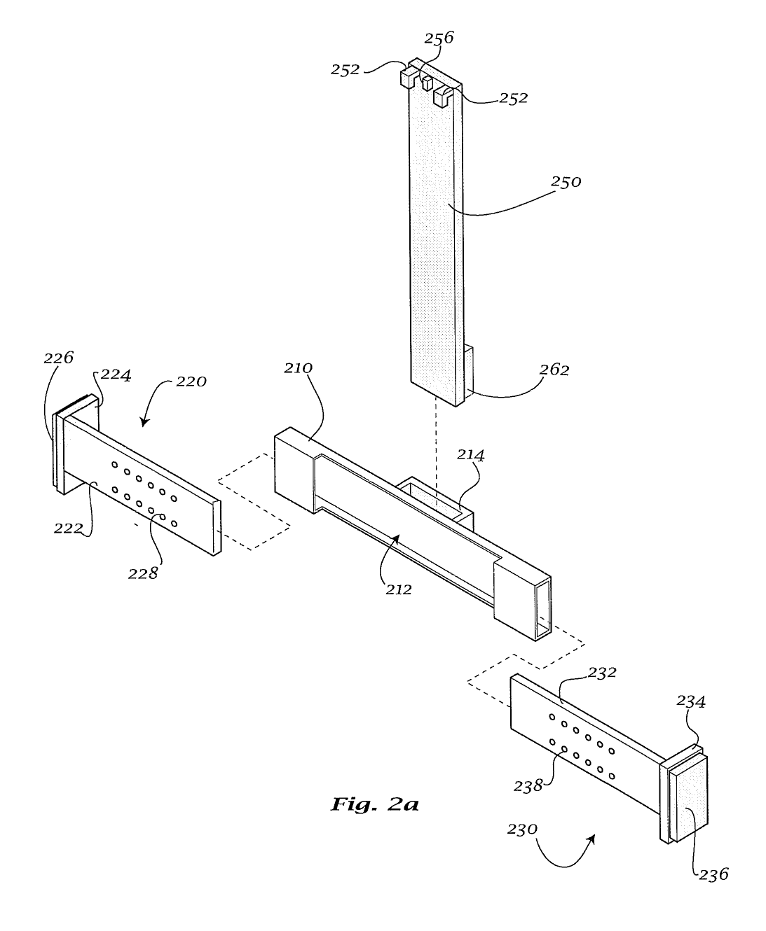

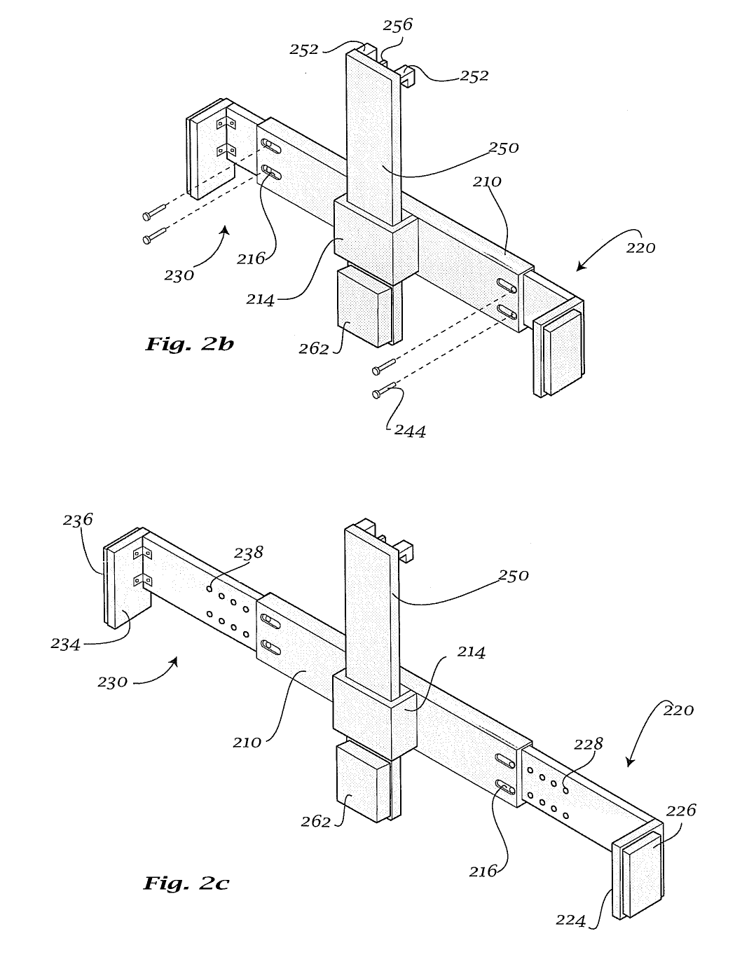

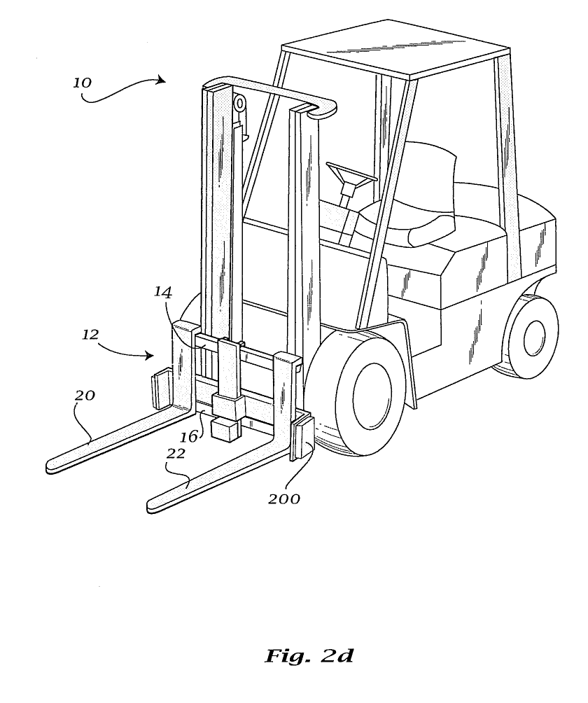

FIGS. 2a-2d show another exemplary embodiment of a pallet and product protector 200. Pallet and product protector 200 may include a housing 210, the housing having a cavity 212 sized to receive a first aim 220 and a second arm 230 therein. Pallet and product protector 200 may further include a vertically elongated plate 250.

Vertically elongated plate 250 may include an impact absorber 262 disposed substantially near the bottom end of vertically elongated portion 260. First impact absorber 262 may be adapted to come into contact with, or impact, the middle stringer of a pallet. Vertically elongated plate 250 may further include at least one L-shaped member 252 disposed adjacent the top end thereof. At least one L-shaped member 252 may extend rearward and downward from vertically elongated plate 250 so as to provide a substantially hook-like configuration that may be removably attached to the upper carriage bar 14 of a forklift or similar apparatus by positioning the at least one L-shaped member 252 over upper carriage bar 14.

Housing 210 may include a U-shaped bracket 214 coupled thereto. U-shaped bracket 214 may be sized so as to allow vertically elongated plate 250 to be received therein. Housing 210 may also include a plurality of apertures 216 defined in a vertical wall thereof.

Received within housing 210 may be first arm 220 and second arm 230. First arm 220 may include a horizontally elongated portion 222, and a bracket 224 disposed at the outside end of first arm 220. Horizontally elongated portion 222 may have a height that is substantially similar to the height of cavity 212 of housing 210, thereby reducing the likelihood of vertical movement of first arm 220 when the arm is disposed within the housing. Coupled to bracket 224 may be impact absorber 226. Horizontally elongated portion 222 may include a plurality of apertures 228 defined therein. Apertures 228 may be grouped in vertical pairs, with the vertical pairs being arranged laterally along the length of horizontally elongated portion 222. The height of bracket 224 may be greater than the height of housing 210, so as to extend below the bottom edge of housing 210. Consequently, when pallet and product protector 200 is mounted on a forklift, bracket 224 may extend below the plane of L-shaped forks 20, 22.

Similarly, second arm 230 may include a horizontally elongated portion 232, and a bracket 234 disposed at the outside end of second arm 230. Horizontally elongated portion 232 may have a height that is substantially similar to the height of cavity 212 of housing 210, thereby reducing the likelihood of vertical movement of second arm 230 when the arm is disposed within the housing. Coupled to bracket 234 may be impact absorber 236. Horizontally elongated portion 232 may include a plurality of apertures 238 defined therein. Apertures 238 may be grouped in vertical pairs, with the vertical pairs being arranged laterally along the length of horizontally elongated portion 232. The height of bracket 234 may be greater than the height of housing 210, so as to extend below the bottom edge of housing 210. Consequently, when pallet and product protector 200 is mounted on a forklift, bracket 234 may extend to, or below the plane of L-shaped forks 20, 22.

First and second arms 220, 230 may be disposed within housing 210 so as to allow arms 220, 230 to be laterally slidably adjustable. The laterally slidable adjustability of first and second arms 220, 230 can allow for pallet and product protector 200 to be used with forklifts having diverse spacings between the L-shaped forks thereof. Such laterally slidable adjustability may also allow for adjusting the span of pallet and product protector 200 for use with pallets having diverse widths.

Apertures 216 of housing 210 may correspond in position to apertures 228 and 238 of first and second arms 220, 230. Apertures 216 may further have an oblong shape so as to allow for the lateral adjustability of apertures 228, 238 with respect to apertures 216. A plurality of fasteners 244 may be received within apertures 216 and corresponding apertures 228, 238 so as to couple first and second arms 220, 230 to housing 210. Fasteners 244 may be bolts, screws, dowels, or any other known fastener that allows pallet and product protector 200 to function as described herein.

Certain carriage bars may include a plurality of regularly spaced index notches provided along the upper portion of the carriage bar. Such index notches can facilitate the positioning of L-shaped forks or other attachments along the carriage bar. Exemplary embodiments of pallet and product protector 200 may thus include a centering nub 256 disposed substantially near the top end of vertically elongated plate 250. Centering nub 256 may be adapted to be received within an index notch of a carriage bar, so as to facilitate precise positioning of pallet and product protector 200 at the midpoint of the carriage bar or at any other desired index notch.

In operation, a user may desire to adjust the lateral span of pallet and product protector 200. To that end, the user may remove fasteners 242 from pallet and product protector 200, thereby decoupling first and second arms 220, 230 from housing 210. The user may then laterally slide first and second arms 220, 230 such that a desired span of pallet and product protector 200 is achieved. To fix arms 220, 230 in the desired positions, the user may then align a desired pair of apertures 228 and 238 with corresponding apertures 216 of housing 210. The user may then insert fasteners 244 through the aligned apertures so as to couple arms 220, 230 to housing 210. FIGS. 2b and 2c show pallet and product protector 200 in a narrow span configuration and a wide span configuration, respectively.

Pallet and product protector 200 may be attached to the carriage assembly of a forklift 10 by positioning the L-shaped members 252 over upper carriage bar 14, and by positioning housing 210 on top of lower carriage bar 16. Pallet and product protector 200 may also be coupled to lower carriage bar 16 by way of a clamping member 16, substantially similar to the clamping member of pallet and product protector 100, or by way of any other known fastener that enables pallet and product protector 200 to function as described herein. Housing 210 may thus be disposed behind L-shaped forks 20, 22. However, impact absorber 262 can be disposed forward of L-shaped forks 20, 22 so as to come in contact with, or impact, the middle stringer of a pallet. Similarly, brackets 224, 234 of first and second arms 220, 230 can be disposed in front of and outside of L-shaped forks 20, 22, so as to come in contact with, or impact, the side stringers of a pallet. Furthermore, during pallet loading and unloading operations, a forklift may approach the pallet at an oblique angle. Oblique impacts may also impart damage to the pallet and to the materials loaded thereon. Therefore, brackets 224, 234 may be positioned so as to reduce the likelihood of damage from oblique impacts.

It should be appreciated that the exemplary embodiments of pallet and product protectors disclosed herein may include impact-absorbing members coupled thereto. Such impact absorbing members may be made out of any known impact absorbing material, for example a resiliently deformable material such as plastic, rubber or foam. Furthermore, the above-described components of the pallet and product protectors may be made from metal, plastic, wood, or any other desired material that enables the pallet and product protectors to function therein, or any combination of such materials. It should also be appreciated that the above-described components of the pallet and product protectors may be coupled to each other by any known coupling. For example, the above described components may be fixedly coupled to each other by welding, adhesion, or any other known coupling. The above described components may also be removably coupled to each other, for example by screws, bolts, dowels, or any other known coupling. Additional couplings of components of the exemplary embodiments of the pallet and product protectors may be contemplated and used as desired.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A pallet and product protector for use with a forklift having a pair of L-shaped forks, comprising:
a front plate comprising a first bracket having a height, a middle plate having a height, a second bracket having a height, a first horizontally elongated portion having a height and extending between the first bracket and the middle plate, and a second horizontally elongated portion having a height extending between the second bracket and the middle plate, the height of the first horizontally elongated portion and the height of the second horizontally elongated portion being less than the height of the first bracket, the height of the middle plate, and the height of the second bracket;
a vertically elongated plate disposed rearward of the front plate and coupled thereto, the vertically elongated plate further comprising a top end, a bottom end, and a pair of L-shaped members disposed adjacent the top end and extending rearward therefrom; and
a clamping member disposed proximate to the middle plate of the front plate and below the vertically elongated plate.

2. The pallet and product protector of claim 1, wherein the front plate further comprises a top edge and a bottom edge, the bottom edge symmetrically defining a first cutout and a second cutout in the horizontally elongated plate, the first cutout being disposed between the first bracket and the middle plate, and the second cutout being disposed between the second bracket and the middle plate.

3. The pallet and product protector of claim 1, further comprising horizontal extensions coupled to each of the first bracket, the middle plate, and the second bracket, and extending forward therefrom.

4. The pallet and product protector of claim 1, wherein the clamping member is removably coupled to the pallet and product protector.

5. The pallet and product protector of claim 4, wherein the distance between the pair of L-shaped members and the clamping member is adjustable.

6. The pallet and product protector of claim 1, further comprising a centering nub disposed proximate the top end of the vertically elongated plate.

7. The pallet and product protector of claim 1, further comprising at least one spacer coupled to the front plate and the vertically elongated plate, and disposed therebetween.

8. The pallet and product protector of claim 1, further comprising impact absorbing material coupled thereto.

9. The pallet and product protector of claim 2, wherein each of the first cutout and the second cutout is adapted to receive a horizontal tong of an L-shaped fork of a forklift.

10. The pallet and product protector of claim 2, wherein the first cutout and the second cutout have a substantially arcuate shape.

11. The pallet and product protector of claim 2, wherein the left cutout and the right cutout have a three-sided rectangular shape.

12. A pallet and product protector for use with a forklift having a pair of L-shaped forks, comprising:
a housing comprising a cavity sized to slidably receive a pair of arms therein;
a first arm slidably disposed within the housing and adapted to be demountably coupled thereto, the first aim comprising at least one horizontally elongated portion and a bracket disposed at the outside end of the horizontally elongated portion;
a second arm slidably disposed within the housing and adapted to be demountably coupled thereto, the right arm comprising at least one horizontally elongated portion and a bracket disposed at the outside end of the horizontally elongated portion; and
a vertically elongated plate disposed rearward of the front plate, comprising a top end and a bottom end, and at least one L-shaped member disposed adjacent the top end and extending rearward therefrom.

13. The pallet and product protector of claim 12, wherein:
the first arm further comprises a plurality of apertures defined in the horizontally elongated portion;
the second aim further comprises a comprises a plurality of apertures defined in the horizontally elongated portion; and
the cover plate further comprises a plurality of apertures defined therein.

14. The pallet and product protector of claim 12, further comprising a centering nub disposed proximate to the top end of the rear plate.

15. The pallet and product protector of claim 12, further comprising a clamping member disposed proximate to the longitudinal midpoint of the housing.

16. The pallet and product protector of claim 12, wherein the housing further comprises a U-shaped bracket coupled to the rear thereof, the U-shaped bracket adapted to receive the rear plate between the U-shaped bracket and the housing.

17. A pallet and product protector for use with a forklift having a carriage assembly and a pair of L-shaped forks, comprising:
means for attaching the pallet and product protector to the carriage assembly of the forklift;
a first impact means for coming into contact with a center stringer of a pallet;
a second impact means for coming into contact with a first side stringer of the pallet; and
a third impact means for coming into contact with a second side stringer of the pallet.

18. The pallet and product protector of claim 17, further comprising:
a first means for absorbing impacts between the pallet and product protector and the center stringer of a pallet;
a second means for absorbing impacts between the pallet and product protector and the first side stringer of the pallet; and
a third means for absorbing impacts between the pallet and product protector and the second side stringer of the pallet.

19. The pallet and product protector of claim 17, further comprising means for providing clearance between the forklift and materials loaded onto and overhanging a pallet.

20. The pallet and product protector of claim 17, further comprising means for varying the distance between the first impact means, the second impact means, and the third impact means.
